(19) United States
(12) Patent Application Publication
(10) Pub. No.: US 2022/0368687 A1
(43) Pub. Date: Nov. 17, 2022

(54) MODULAR SECURE REMOTE WORK PLATFORM

(71) Applicant: Modsquad, Inc., Sacramento, CA (US)

(72) Inventors: Mary Lex, San Francisco, CA (US); Mark Olsen, San Francisco, CA (US); Timothy Rolston, Big Rapids, MI (US)

(21) Appl. No.: 17/746,211

(22) Filed: May 17, 2022

Related U.S. Application Data
(60) Provisional application No. 63/189,599, filed on May 17, 2021.

(51) Int. Cl. H04L 9/40

(52) U.S. Cl. CPC H04L 63/08; H04L 63/20; H04L 63/10; H04L 63/0272

(57) ABSTRACT

There is disclosed a system for secure remote work. An associated client computer may receive a login attempt from a user, provide login credentials received from a user to a remote computing device for authentication. The client computer may then receive confirmation of authentication along with a request for security protocol testing in conformity with security requirements for access to a secure remote work environment, perform security protocol testing on the client computing device, and provide security protocol test results generated by the security protocol testing to the remote computing device. Thereafter, the remote client may access to the secure remote work environment upon confirmation that the security protocol test results pass the security protocol testing.

### RELATED APPLICATION INFORMATION

This patent claims priority from provisional patent application No. 63/189,599, filed May 17, 2021 and entitled “MODULAR SECURE WORK FROM HOME PLATFORM.”

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to secure work environments and, more particularly, to an architecture for ensuring that unmanaged computing devices conform to a required level of security before they are granted access to a secure work environment and secured information.

### Description of the Related Art

Work from home or remote working environments have changed the world for the better in the last 20 years. Beginning in the early 2000s, VPNs (virtual private networks) and remote desktop systems have become ubiquitous. These systems enable remote access to files, desktops, databases, or other information needed for employees to carry out their work from remote locations.

Traditionally, these systems have been enabled through the use of secure authentication to their associated systems. So, for example, a user may be required to enter a password to obtain remote access to his or her desktop. In more secure integrations of this type, a user may be required to first connect to a virtual private network, and may thereafter obtain access to a remote desktop or network resources (e.g. databases, file servers, etc.). VPNs and remote desktops and similar remote file systems can be protected by basic passwords or may require local and remote shared public and private authentication keys that must match before users are able to connect. These different architectures offer differing levels of security and are more or less difficult to enable and to administer. In general, the more secure these systems are, the more complicated they are to maintain and the more service calls are required to IT support in order to ensure they continue to work for employees and other users.

Because the most-secure of these systems are difficult for end users and require near-constant tech support in some cases to maintain them in working order, third party service providers have increasingly tried to streamline or simplify these types of secure connections without requiring complicated pre-shared keys, encryption, and software installs.

One example of a recent attempt to streamline this type of connection is provided by Microsoft Remote Desktop. In the past, Microsoft Remote Desktop was simply another virtual desktop software. Over time, it has been integrated into other Microsoft services. Most serious users of Microsoft services have a Microsoft login at this point. Windows 8 and Windows 10 and 11, as well as presumably all versions for the foreseeable future, virtually require users to have a Microsoft account. Business users who rely upon Microsoft Office software and email have business logins associated with their user accounts.

Microsoft Remote Desktop has recently been augmented to enable authentication and a secure connection to email and network resources using these logins. Those connections can be automatically encrypted and provide secure access to network resources as configured by a network administrator who enables the remote desktop service on an associated Windows server. This places control at least somewhat centrally located on the associated Windows server. However, Windows server has limited capability of understanding the environment on the client computer which is connected to the server. In general, Windows server does not care to inspect the computers connected to it. The person connecting is authenticated, and the data being operated upon is data to which they are generally entitled access. When there is a concern, the administrator can require that a connecting device be one that is also administered by the same IT admin as the Windows server. In most cases, these persons are employees. So, demands can be easily made of them, computers may be provided (e.g. laptops for remote work), and there is simple and significant recourse should some issue arise with use or mis-use of any data or network systems. For example, those employees may simply be fired or access may be revoked.

However, some types of data and systems are particularly prone to theft, or access to that data may become the target of organized efforts to access that data. For example, a database of health information is protected by specific laws in most countries requiring that access be specifically limited, that it not be disclosed to groups of individuals or others outside of certain requirements. In addition, such data is required to be maintained encrypted and with carefully protected access. Similarly, the U.S. Department of Defense has limitations on the types of data that may be accessed and how that data may be accessed. Insurance companies have similar limitations on access to customer data. Even data sets or industries without specific requirements are increasingly careful about such data out of fear of data breaches and potential liability resulting therefrom.

In all of these situations and others, entities must carefully control access to some data sets or IT infrastructure. Nonetheless, virtually all of these systems require limited or controlled access to that data to enable customer service operations. An insured must call an insurance service provider with questions about their policy or claims. The person answering the phone must have access to the customer's data. Likewise, customer service for a medical provider or for a financial institution must have access to the user's data in order to provide service.

As the entire world has seen in the midst of the COVID-19 pandemic, work from home may in dire situations become an absolute requirement. Certain countries simply require individuals to stay home for indeterminate times. In other cases, workers may wish or prefer to stay home or to work from home. For example, older workers or individuals with pre-existing conditions may desire to work from home. In other cases, work from home or remote working, e.g. from a different country, may be the best, a desired, or the least expensive option. In each of these cases and others, the individuals may or may not be employees of a given entity. Direct control over their computing devices or the places where they access secure data may be limited or non-existent or there may be legal reasons why a given entity wishes to exercise “loose” control over a given contractor.

In such cases, it is desirable to ensure the security of a computing device that a given user is using to access secure resources while not exercising absolute control over those computers. In addition, the users themselves may not want that control by a part-time job or contract work that is being done. A simplified system and method to ensure that access locations are adequately secure, and that the system is not otherwise compromised, is desirable. It would be preferable if the secure access system did not require the installation of complicated software or systems that must be administered by IT infrastructure and which would require the heavy involvement of IT administrators.

### DESCRIPTION OF THE DRAWINGS

FIG. 1 is an overview of a system for secure remote work.

FIG. 2 is a functional diagram of a system for secure remote work.

FIG. 3 is a block diagram of a computing device.

FIG. 4 is a series of example screen captures from a system for secure remote work.

FIG. 5 is a series of example screen captures from a system for secure remote work.

FIG. 6 is a series of example screen captures from a system for secure remote work.

FIG. 7 is a flowchart of access by a remote worker to a system for secure remote work.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

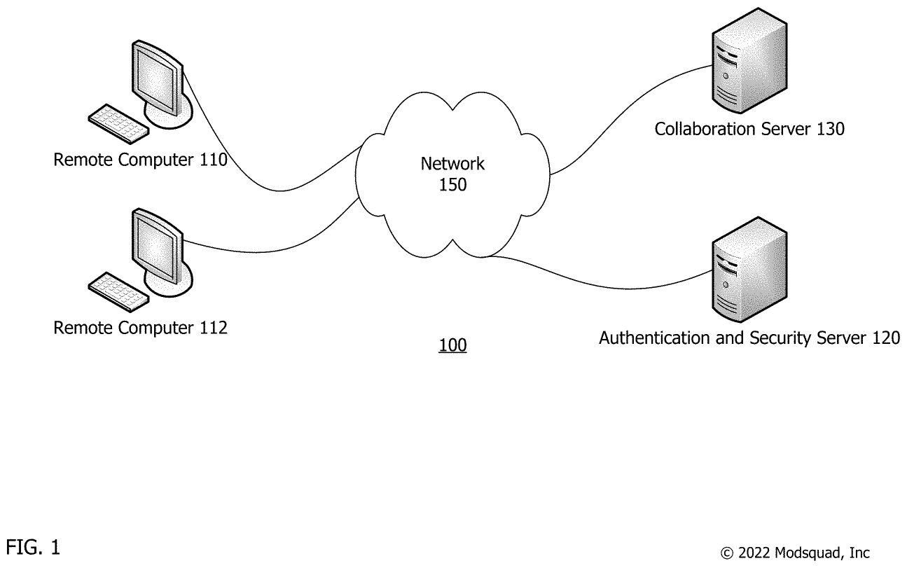

Referring now to FIG. 1, an overview of a system 100 for secure remote work. The system 100 includes a remote computer 110, a remote computer 112, an authentication and security server 120, and a collaboration server 130 all interconnected by a network 150.

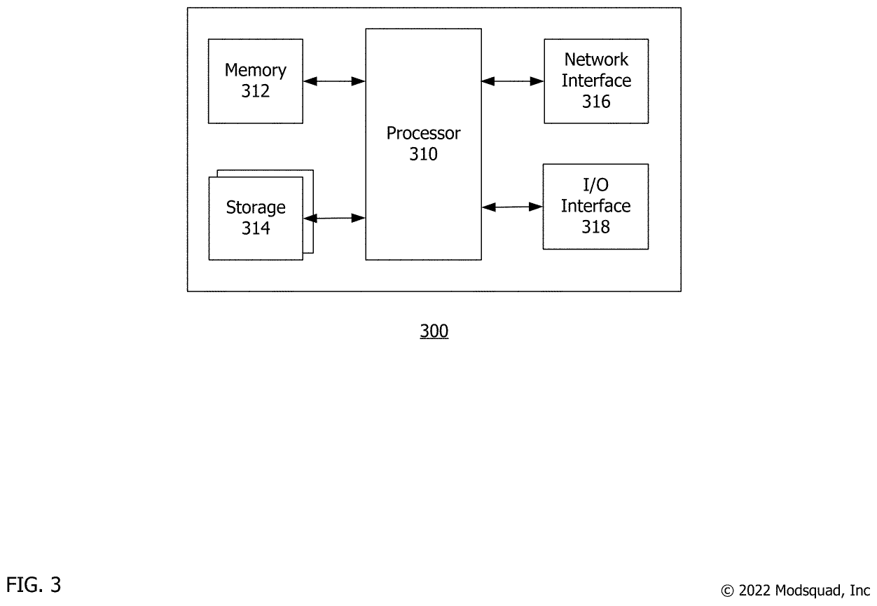

The remote computer 110 is a computing device (see FIG. 3) that is used by a user to access the collaboration server 130 and that is authenticated and security is confirmed by the authentication and security server 120. The remote computer is preferably a desktop or laptop computer, but may be a tablet device (e.g. an Apple® iPad® device, mobile device or hybrid device (e.g. Microsoft® Surface® device). The remote computer 110's primary purpose is to enable a remote user to access a secure remote work environment.

As used herein a “secure remote work environment” means a desktop environment provided using technology such as an encrypted partition or streaming or similar service to a remote computer (e.g. the remote computer 110) upon confirmation that the remote computer complies with a security protocol. The “secure remote work environment” is a DaaS (desktop as a service) which may be hosted remotely from the remote computer on a server or may be maintained in a secure, isolated partition, virtual machine, or otherwise separated logically, virtually, or physically from the remote computing device while being generated by the remote computing device. There may be a plurality of different secure remote work environments available for access.

The phrase “security protocol” as used herein means a set of security standards for a remote computer (e.g. remote computer 110) that are required to be met before access to the secure remote work environment is enabled. The “security protocol” is defined by the operator or administrator of the secure remote work environment. The “security protocol” may, at least in part, be defined by requirements to comply with legal, regulatory, or corporate policy requirements. An independent security protocol may be defined and required to be met for access to each secure remote work environment.

The remote computer 112 is substantially the same as remote computer 110. It is shown merely to indicate that a multiplicity of remote computers may connect or otherwise be authenticated and secured by the system 100.

The authentication and security server 120 is a computing device (see FIG. 3). The authentication and security server 120 is primarily responsible for ensuring compliance by remote computers with the security protocol necessary for access to a given secure remote work environment. Though shown as a single computing device, the authentication and security server 120 may be one or more physical computing devices. In a preferred embodiment, the authentication and security server 120 is in fact multiple servers, which may operate as one or more cloud services offered by the applicant or by third parties.

As will be discussed more fully below, there are multiple layers of authentication and security. The authentication and security server 120 may provide authentication (e.g. with a username and password and a two-factor authentication system or biometric authentication system), but may also confirm a number of elements about the remote computer 110 that is requesting access to the collaboration server 130. For example, the authentication and security server 120 may confirm that one or more hard drives on the remote computer 110 are encrypted, that an antivirus software is present and its definitions are up-to-date, that an encrypted connection is being made for the authentication process (e.g. employing an SSL certificate), that the browser being used to login is up-to-date to avoid obvious or known security issues, that a firewall is present and operating, that operating system and other software are up-to-date.

In other cases requiring further security, the authentication and security server 120 may confirm that anti-screen capture software is installed, that there is no removable media (e.g. USB sticks, SD cards) inserted into the remote computer 110, that keylogging is taking place (for review) or that no keylogging software is present (to avoid capture of passwords and confidential information), disable or ensure non-use of screen capture of the DaaS, that a recent antivirus scan has taken place, ensuring that data may not be moved to the remote computer 110 from the DaaS while the DaaS is active, and other options. In still other cases, the authentication and security server 120 may confirm using biometric data (e.g. a fingerprint or an periodic video camera capture) that the user who logged into the system remains the user operating the system. Or the authentication and security server 120 may use an associated video camera to monitor for cellular devices attempting to capture an image of the screen or disablement of the associated video camera—potentially for those purposes.

The authentication and security server 120 operates remotely from the remote computer 110 and they are connected by the network 150. In general, no additional software is required to be installed on the remote computer 110 to make these various checks. There is at least one browser plugin that is required to enable access to the authentication and security server 120 to confirm the status of all of these potential security protocol issues. The operator of this system does not require that the user install any software, but does require that certain software be installed prior to access to a DaaS (subject to some limitations discussed below). This matters in some jurisdictions for purposes of differentiating between employees and contractors and potentially subjecting the operator of this system or its customers to potential regulatory compliance with different sets of laws. However, once this plugin software is installed, the security protocol checks may be made as discussed more fully below.

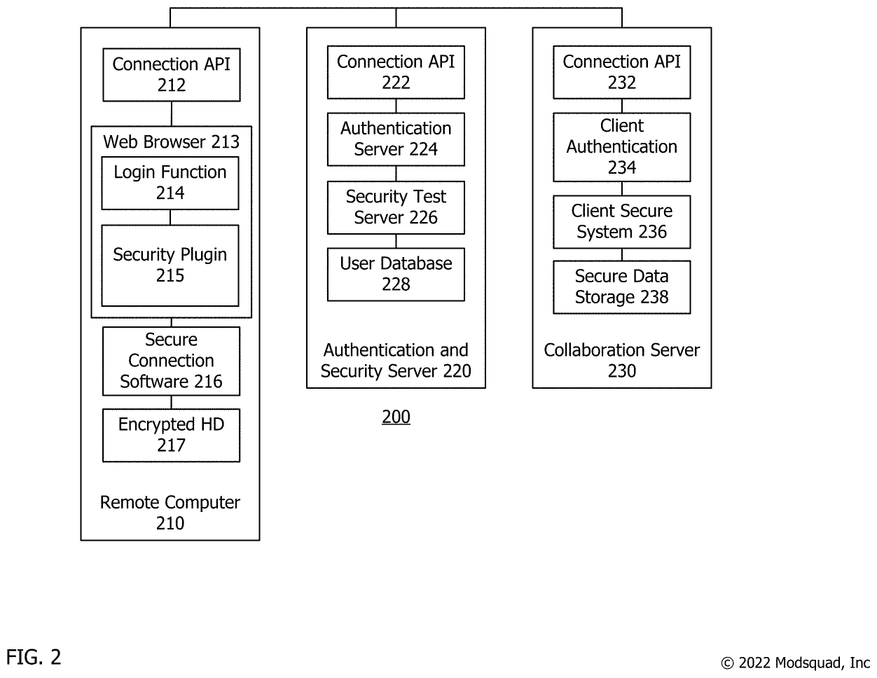

The collaboration server 130 is a computing device (see FIG. 2). It is shown as a single computer in FIG. 1, but it may in fact be a number of physical computers. The collaboration server 130 is preferably a secured remote desktop. That desktop itself may enable access to one or more databases, custom software, file servers, or other software available on the collaboration server 130. The collaboration server 130 takes a number of forms, but in general provides the secure remote work environment to which the user is obtaining access following confirmation by the authentication and security server 120 that the security protocol associated with the collaboration server 130 has been passed by a remote computer (e.g. remote computer 110).

The network 150 is a computer network that connects the various components of the system 100. The network 150 may be or include the internet, but may also rely upon local networks, WANs, LANs, or wireless technologies such as 802.11x and Bluetooth® technologies. Regardless, the network 150 is one that is suitable of enabling the remote computer 110 to connect to the collaboration server 130 in conformity with the security protocol required to access the collaboration server 130

FIG. 2 is a functional diagram of a system 200 for secure remote work. The system 200 includes a remote computer 210, an authentication and security server 220 and a collaboration server 230, each discussed above in FIG. 1.

The remote computer 210 includes a connection API 212, a web browser 213 including a login function 214 and security plugin 215, secure connection software 216, and an encrypted hard drive 217.

The connection API 212 is software responsible for enabling connection and communication between the remote computer 210 and the authentication and security server 220 and the collaboration server 230. The connection API 212 may define certain parameters for that communication including encryption of the data, the use of public and private keys to encrypt the data, and may define basic attributes such as internet or network locations to which to direct communications and the expected and required format of those communications.

The web browser 213 may be a relatively ordinary web browser software on the remote computer 213. The web browser 213 may provide the first level of connection between a remote computer 210 and the authentication and security server 220 and the collaboration server 230. The web browser 213 is used because virtually every computer connected to the internet or that may be used by a more computer 210 will have a web browser 213. It serves as a suitable first step and easy gateway to the other security provided by the present system 200.

The login function 214 is computer software that may be temporarily downloaded in the form of an encrypted web page to enable a user of the remote computer 210 to input their login credentials as a first step to authentication with the authentication and security server 220. Again, the login function 214 is a part of the web browser 213 because it will be easy for a remote user to access and use as most users are familiar with logging into websites using a web browser.

The security plugin 215 is a plugin to the web browser 213 that must be downloaded and installed on the remote computer 210 to enable the authentication and security server 220 to perform a security protocol check to ensure that the remote computer 210 is adequately protected to conform to the required security protocol for access to the collaboration server 230.

The security plugin 215 once initiated by a login attempt may check various aspects of the remote computer 210. These can include security patch status of the underlying operating system and any software (e.g. the web browser), encryption of the hard drive being used on the computer, the absence or presence of certain software (e.g. no keyloggers, firewall and anti-virus software), the patch status of certain software. The security plugin 215 may disable or render inoperable print screen functionality or access to USB (or other) removable drives. Or, the security plugin 215 may merely check to confirm the status of each of these attributes and, in the absence of one or more required by a given security protocol for a collaboration server 230, the security plugin may operate in conjunction with the authentication and security server 220 to deny access to the collaboration server 230.

The secure connection software 216 is software that enables secure connection (e.g. an encrypted connection) to the collaboration server 230 following authentication and confirmation that the remote computer 210 passes the associated security protocol test. This secure connection software 216 may be a commercial-grade remote desktop software that allows for remote monitoring and administration by IT professionals. Alternatively, the secure connection software 216 may be custom software that provides direct access to the collaboration server 230.

The encrypted hard drive 217 is a long-term storage drive used by the remote computer 210 while it is accessing the collaboration server 230. Encryption is required because in some form data from the collaboration server 230 will be present on that remote computer 210. In most cases, no actual transfer of files is made from the collaboration server 230 to the remote computer 210, but even remote desktop server software sends a data stream of images of the remote desktop being operated by the remote computer 210. So, that data stream is preferably encrypted when received on the encrypted hard drive 217 on the remote computer 210.

The authentication and security server 220 includes a connection API 222, an authentication server 224, a security test server 226, and a user database 228. As indicated above, the authentication and security server 220 is shown as a single server but may in fact be one or more physical servers operating remote from one another and in concert.

The connection API 222 is software that operates in much the same way as the connection API 212 of the remote computer 210. It may include SSL to ensure a secure connection between the connection API 212 and the connection API 232. The connection API 222 enables the authentication and security server 220 to communicate with various other computers.

The authentication server 224 is software operating on the authentication and security server 220 responsible for comparing user input authentication data (e.g. username and password) with a corresponding record to ensure that a user attempting to login (e.g. from remote compute 210) is authorized to access the collaboration server 230. The username and password are preferably encrypted and salted on the authentication and security server 220 to avoid the possibility of plaintext username and password being exposed by a hack of the authentication and security server 220. Authentication by the authentication server 224 may involve the use two-factor authentication which may, in fact, be required by some security protocols. Biometric authentication may be required in other cases.

The security test server 226 is software operating on the authentication and security server 220 responsible for ensuring that the remote computer 210 is currently employing adequate security, according to an associated security protocol, to access the collaboration server 230. The security test server 226 may refer to information in the user database 228 to make this determination. But, as a part of any authentication process, the remote computer 210 may indicate the network or collaboration server 230 resources to which it requests access. In response, the authentication and security server may identify the associated security protocol. Thereafter, the security test server 226 may operate in conjunction with the security plugin 215 on the remote computer 210 to ensure that the remote computer is employing adequate security protocols to be authorized to access the collaboration server 230.

The user database 228 may store data pertaining to each user and may store historical data pertaining to the remote computer(s) used by a given user to access the collaboration server. In addition, the user database 228 may store data identifying the collaboration server or collaboration servers which the user is authorized to access and the associated security protocols for each collaboration server, like collaboration server 230.

The collaboration server 230 is software operating on a computing device (FIG. 2) that includes a connection API 232, client authentication 224, client secure system 226, and secure data storage 228. As indicated above, the collaboration server 230 is shown as a single server but may in fact be one or more physical servers operating remote from one another and in concert. A single collaboration server 230 is shown, but there may be many accessible to a give remote computer 210 and/or authentication and security server 220. Each collaboration server 230 may be served by one or more authentication and security server 220 to ensure access and security protocols associated with each collaboration server are met by all individuals accessing that server.

The connection API 232 is software serving much the same functions as described with respect to connection API 212 and connection API 222. The software enables the collaboration server 230 to communicate with other devices.

The client authentication 234 is software operating on the collaboration server 230 to authenticate the user of the remote computer 210 to the collaboration server. Preferably, this function may be integrated with the authentication server 224, but in some cases, a separate authentication may be required for the collaboration server 230 itself. In such cases, the client authentication 234 operates to perform this function.

The client secure system 236 is software operating on the collaboration server 230 to enable the remote computer 210 user to access the secure remote work environment. The client secure system 236 is preferably a DaaS system wherein a remote computer 210 is presented with a functional desktop, including all relevant software pre-installed, for use in accessing data necessary to do the required work. That data may be client medical records, insurance records, driving records, court records, or other confidential corporate records or information. The use of a DaaS service enables better control over the location of the information and how it is transmitted—or not transmitted—from the collaboration server 230. The authentication and security server 220 and the other security safeguards provided by this system 200 help to ensure that only the proper individuals are accessing the data, and the client secure system 236 ensures that those people are entitled to only do what they are allowed to do with that data.

The secure data storage 238 is a file server or database accessible to users of the collaboration server 230 (e.g. using the client secure system 236) to perform the work required of those users. The secure data storage 238 is preferably encrypted and access may be limited to only certain numbers of records or only certain record types dependent upon the type of user operating the remote computer 210 accessing the collaboration server 230 and the associated security protocols.

Turning now to FIG. 3, a block diagram of a computing device 300 is shown. The computing device 300 may be representative of the server computers, client devices, mobile devices and other computing devices discussed herein. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 may have a processor 310 coupled to a memory 312, storage 314, a network interface 316 and an I/O interface 318. The processor 310 may be or include one or more microprocessors and application specific integrated circuits (ASICs).

The memory 312 may be or include RAM, ROM, DRAM, SRAM and MRAM, and may include firmware, such as static data or fixed instructions, BIOS, system functions, configuration data, and other routines used during the operation of the computing device 300 and processor 310. The memory 312 also provides a storage area for data and instructions associated with applications and data handled by the processor 310. As used herein, the word memory specifically excludes transitory medium such as signals and propagating waveforms.

The storage 314 may provide non-volatile, bulk or long-term storage of data or instructions in the computing device 300. The storage 314 may take the form of a disk, tape, CD, DVD, SSD, or other reasonably high capacity addressable or serial storage medium. Multiple storage devices may be provided or available to the computing device 300. Some of these storage devices may be external to the computing device 300, such as network storage or cloud-based storage. As used herein, the word storage specifically excludes transitory medium such as signals and propagating waveforms.

The network interface 316 is responsible for communications with external devices using wired and wireless connections reliant upon protocols such as 802.11x, Bluetooth®, Ethernet, satellite communications, and other protocols. The network interface 316 may be or include the internet.

The I/O interface 318 may be or include one or more busses or interfaces for communicating with computer peripherals such as mice, keyboards, cameras, displays, microphones, and the like.

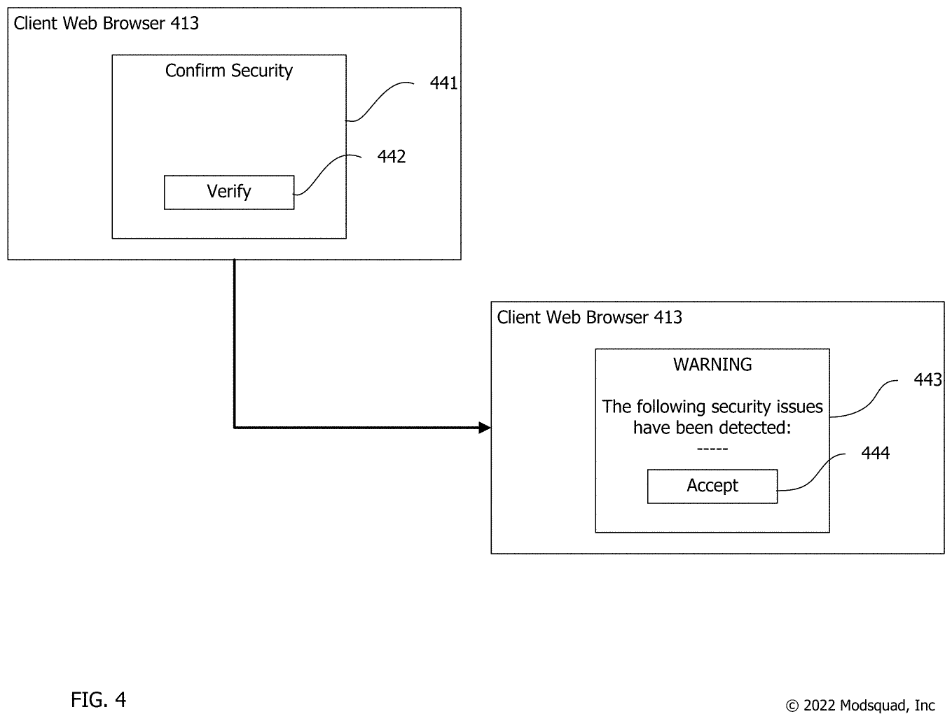

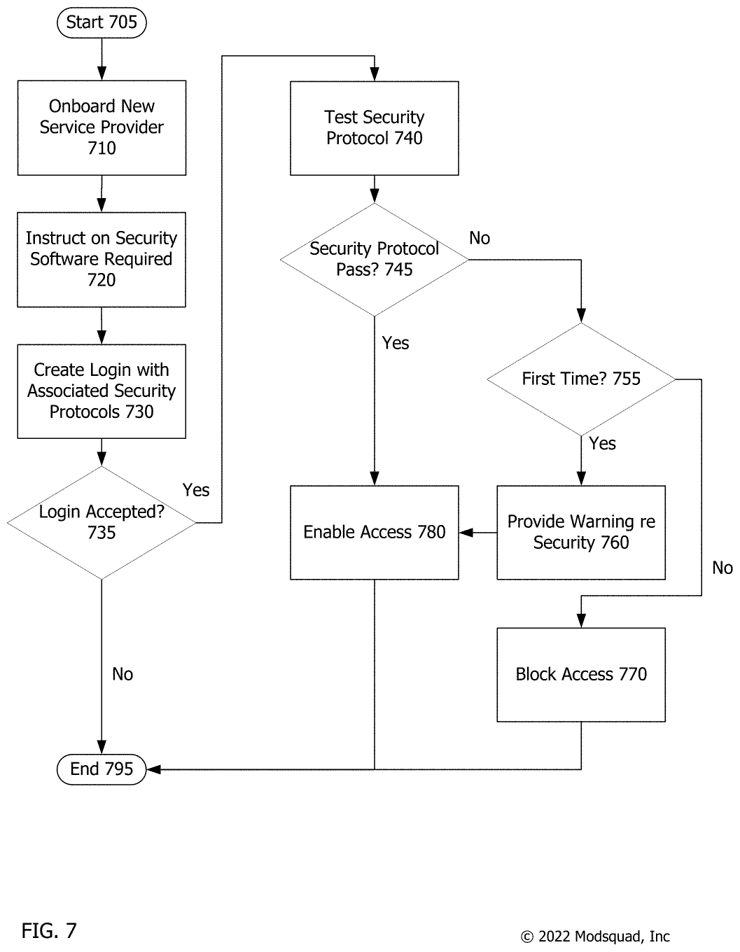

FIGS. 4, 5, and 6 are a series of example screen captures from a system for secure remote work. Each will be discussed below with reference to FIG. 7.

Description of Processes

Referring now to FIG. 7, a flowchart of access by a remote worker to a system for secure remote work is shown. The process begins at start 705 and ends at end 795. Many instances of some or all of this process may be taking place simultaneously with different remote clients so as to authenticate and ensure adequate security for remote computers accessing various secure remote work environments.

Following the start, the first step is to onboard a new service provider at 710. This process may be automated to the extent possible, but may also rely upon manual processes undertaken by individuals. So, for example, this process may involve automated or manual or both types of background checks. A typical background check may involve checking credit and criminal history. This process can generally be automated by software. However, review of the resulting background report typically must be done manually. The necessity and rigor of a background check may depend entirely upon the desired or regulatorily-required level of security demanded for a given data access or remote user to access a given secure remote work environment.

In some cases, a more rigorous or manual background check may be required (e.g. interviewing past associates and employers). In addition, the onboard new service provider 710 process may involve setting up an account with an authentication and security server 220 to enable the user to access one or more secure remote work environments. There may also be security and safety training procedures that may be undertaken—e.g. online training in avoiding obvious security risks (clicking unknown links, sharing passwords, etc.)—that may be undertaken as a part of the onboarding process. A user may be provided with software to enable a two-factor authentication key. Other onboarding processes, as required by a given security process, may be completed at this time.

Next, a user may be instructed on the security software that is required at 720. As indicated above, a user's remote computer 210 must have a security plugin 215 installed. In some more-secure cases, other software may be required, or encryption must be enabled. At this step 720, the user will be advised as to what processes must be undertaken to enable access to one or more secure remote work environments. Importantly, the typical operator of this kind of system desires to have as “soft touch” an involvement with its users as possible. That is for both regulatory and cost reasons. Accordingly, an IT staff will not be taking over “ownership” of or management of a remote computer 210. Instead, the user will be instructed the steps that need to take place for their own computer to access the DaaS systems. As will be discussed below, reminders may be provided as-needed. The software may include encryption software, firewall software, and VPN software.

Once those onboarding processes and instructions in security software are provided, the remote computer 210 may be used to create a login using the associated security protocols at 730. This process may be simply a typical username and password or may include two-factor and/or biometric authentication. The same login may be used with multiple secure remote work environments as the security and authentication processes are separate from the actual access to the secure remote work environments. However, each secure remote work environment may include its own security protocols.

Once those first three steps are completed at 710, 720, and 730, the system may wait until access to a secure remote work environment is requested by a user.

Thereafter, a login may be input by a user at 735. If the login attempt fails (“no” at 735) with the password wrong, two-factor authentication wrong, biometric authentication wrong, or other issues, then the process may end at 795.

If the login attempt is successful (“yes” at 735), then the next step is to test the security protocol at 740. As discussed above, the security protocol can vary from secure remote work environment to secure remote work environment. In general, a minimum level of security will be required involving authentication, encrypted hard drives, firewall and anti-virus software (both patched and up-to-date). Other security protocols may require more or stronger security. Some may require disabling access to remote drives (e.g. USB sticks), continuous or periodic authentication, biometric authentication, two-factor authentication, a continuously-operating software or plugin to ensure that required conditions are met throughout a given access session, periodic antivirus scanning or other processes.

The required security protocol at 740 will vary depending upon the secure remote work environment to which a user is requesting access. If the security protocol passes (“yes” at 745), then access is enabled at 780 to the user's remote computer 210. No particular warning or instruction is likely to be provided, other than potentially a warning about maintaining vigilance about security and privacy of the information that the user may see. Otherwise, the user is provided with a DaaS that includes any software applications (e.g. databases, communication systems, etc.) that are needed to provide the desired support or access.

Many of these users in a preferred use case for users of this system are moderators on websites, customer service representatives for various entities and companies. In such cases, those authenticated and secured individuals may be provided access to a communications channel (e.g. Slack or Teams, but others may be used) and to a database software for clients or customers of the entity for which the users are working on behalf.

If the security protocol is not passed by the remote computer 210 (“no” at 745), then a determination is made whether this is the first time accessing the secure remote work environment or not at 755. In some cases or for some situations, having a single failure or missing element of a security protocol may not be a reason to bar a potential remote user for a single session or misstep or misconfiguration of software. This may particularly be the case during an onboarding and training process. If that is the case, then a first time check at 755 may be used.

In such cases, if it is the first time (“yes” at 755), then a warning may be provided regarding security at 760. An example of this type of warning is shown in FIG. 3. There, a first screen shows a client web browser 413 on a remote computer 210. A popup 441 on a login screen asks the user to confirm security by selecting a verify button 442. After hitting verify, a security check is performed by the security plugin 215. If this is the user's first time confirming conformity with a security protocol, then a warning 443 may be issued, with an accept button 444. The warning 443 provides information on the security issues that were detected and offers options for correcting those issues (e.g. software links to download necessary software, links to instructions on how to encrypt a hard drive, instructions on setting up two-factor authentication, etc.). However, once a user selects the accept putting 444, access is still enabled at 780 for that user. This is to enable the user opportunity and instructions how to correct any security issues. This one-time access may not be available in all cases, depending on a given security protocol for a particular secure remote work environment.

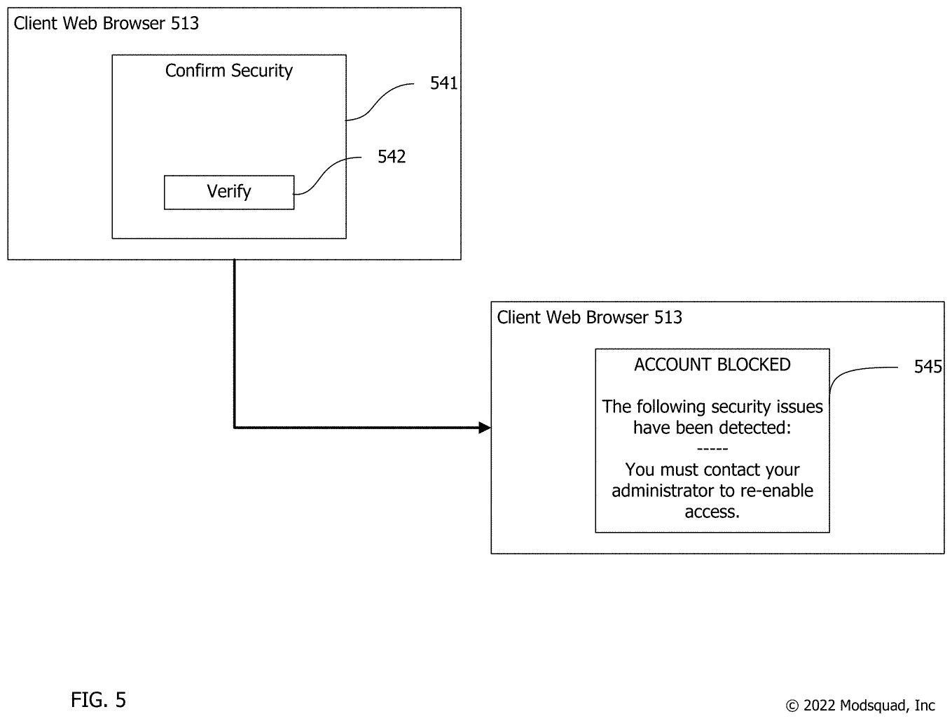

If it is not the first time (“no” at 755), then access is blocked at 770. However, the user is again given instructions on how to re-enable access. An example set of displays are shown in FIG. 5. Here, the same popup 541 requesting that the user confirm security 541 using the security plugin 215 appears. The user selects the verify button 542 whereupon the security check on the remote computer 210 is run. Next, when this is not the first attempted login, the client web browser 513 shows a new warning detailing the security issues detected, providing instructions and/or links on how to address the security issue, and then the account is blocked and the user is notified that they must contact an administrator to re-enable access to the system. This way, the administrator can provide additional support, if needed, and confirm that the security protocol instructions have been followed. Later, access may then be provided.

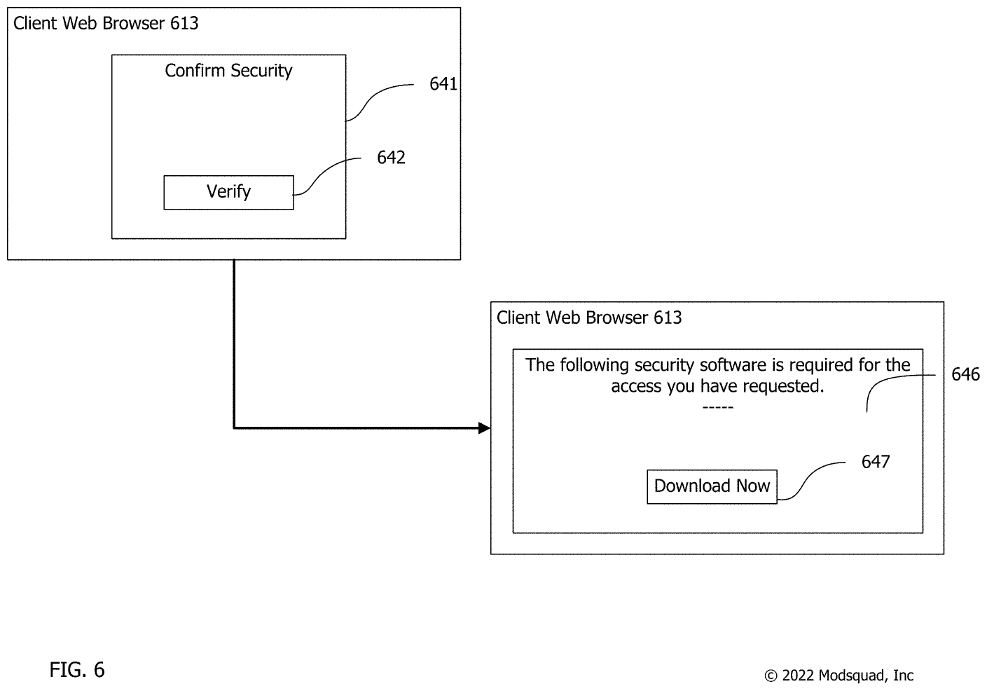

In the particular case where security protocol was previously followed, but the user has since disabled the security plugin 215 or their system no longer passes the security protocol after previously passing it (“no” at 755), an additional warning may be displayed. That is shown in FIG. 6. There, following a login attempt and confirmation of security at popup 641 by hitting verify button 642, the user is presented within the client web browser 613 an instructional popup 646 indicating the software that must be re-installed or re-enabled and providing a direct download link at 647. In this way, a user whose system previously complied (e.g. it is not their “first time” logging into the system), who presumably knows how to have that remote computer 210 in conformity with a given security protocol, is likely to be able to bring his or her remote computer 210 back into conformity with a required security protocol in order to re-obtain access to the secure remote work environment.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for secure remote work, the system comprising a client computing device for:
receiving a login attempt from a user;
providing login credentials received from a user to a remote computing device for authentication;
receiving confirmation of authentication along with a request for security protocol testing in conformity with security requirements for access to a secure remote work environment;
performing security protocol testing on the client computing device;
providing security protocol test results generated by the security protocol testing to the remote computing device;
accessing the secure remote work environment upon confirmation that the security protocol test results pass the security protocol testing.

2. The system of claim 1 wherein access to the secure remote work environment is enabled for a single login when the security protocol test results do not pass the security protocol testing.

3. The system of claim 2 wherein the client computing device provides a warning regarding the failure of the remote computing device to pass the security protocol testing including directions to ensure that the client computing device will pass the security protocol testing in future access attempts.

4. The system of claim 2 wherein access to the secure remote work environment is disabled after the single login when the security protocol test results do not pass the security protocol testing.

5. The system of claim 1 wherein access to the secure remote work environment is provided through an encrypted virtual private network and relies upon a secure remote desktop environment wherein necessary software and data access is limited to the secure remote desktop environment and not installed locally on the client computing device.

6. The system of claim 1 further comprising a server computing device for:
receiving confirmation of authentication of the client computing device;
accessing a security protocol testing database to identify the security protocol testing in conformity with security requirements for access to a secure remote work environment, the security requirements set by an administrator of the secure remote work environment;
providing the client computing device with the request for the security protocol testing in conformity with security requirements for access to a secure remote work environment;
receiving security protocol test results from the client computing device;
enabling access by the client computing device to the secure remote work environment upon confirmation that the security protocol test results pass the security protocol testing.

7. The system of claim 7 wherein the secure remote work environment and the server computing device are independent computing devices, remote from one another.

8. A method for secure remote work, the method comprising:
receiving a login attempt from a user;
providing login credentials received from a user to a remote computing device for authentication;
receiving confirmation of authentication along with a request for security protocol testing in conformity with security requirements for access to a secure remote work environment;
performing security protocol testing on the client computing device;
providing security protocol test results generated by the security protocol testing to the remote computing device;
accessing the secure remote work environment upon confirmation that the security protocol test results pass the security protocol testing.

9. The method of claim 8 wherein access to the secure remote work environment is enabled for a single login when the security protocol test results do not pass the security protocol testing.

10. The method of claim 9 wherein the client computing device provides a warning regarding the failure of the remote computing device to pass the security protocol testing including directions to ensure that the client computing device will pass the security protocol testing in future access attempts.

11. The method of claim 9 wherein access to the secure remote work environment is disabled after the single login when the security protocol test results do not pass the security protocol testing.

12. The method of claim 8 wherein access to the secure remote work environment is provided through an encrypted virtual private network and relies upon a secure remote desktop environment wherein necessary software and data access is limited to the secure remote desktop environment and not installed locally on the client computing device.

13. The method of claim 1 further comprising:
receiving confirmation of authentication of the client computing device;
accessing a security protocol testing database to identify the security protocol testing in conformity with security requirements for access to a secure remote work environment, the security requirements set by an administrator of the secure remote work environment;
providing the client computing device with the request for the security protocol testing in conformity with security requirements for access to a secure remote work environment;
receiving security protocol test results from the client computing device;
enabling access by the client computing device to the secure remote work environment upon confirmation that the security protocol test results pass the security protocol testing.

14. The method of claim 13 wherein the secure remote work environment and the server computing device are independent computing devices, remote from one another.

15. A non-volatile machine readable medium storing a program having instructions which when executed by a processor will cause the processor to:
receive a login attempt from a user;
provide login credentials received from a user to a remote computing device for authentication;
receive confirmation of authentication along with a request for security protocol testing in conformity with security requirements for access to a secure remote work environment;
perform security protocol testing on the client computing device;
provide security protocol test results generated by the security protocol testing to the remote computing device;
access the secure remote work environment upon confirmation that the security protocol test results pass the security protocol testing.

16. The apparatus of claim 15 wherein access to the secure remote work environment is enabled for a single login when the security protocol test results do not pass the security protocol testing.

17. The apparatus of claim 16 wherein the client computing device provides a warning regarding the failure of the remote computing device to pass the security protocol testing including directions to ensure that the client computing device will pass the security protocol testing in future access attempts.

18. The apparatus of claim 16 wherein access to the secure remote work environment is disabled after the single login when the security protocol test results do not pass the security protocol testing.

19. The apparatus of claim 15 wherein access to the secure remote work environment is provided through an encrypted virtual private network and relies upon a secure remote desktop environment wherein necessary software and data access is limited to the secure remote desktop environment and not installed locally on the client computing device.

20. The apparatus of claim 2 further comprising:
the processor; and
a memory;
wherein the processor and the memory comprise circuits and software for performing the instructions on the storage medium.
